(19) United States
(12) Patent Application Publication
(10) Pub. No.: US 2012/0080412 A1
(43) Pub. Date: Apr. 5, 2012

(54) DEVICE FOR PROVIDING A FLOW OF PLASMA

(76) Inventors: Thomas Bickford HOLBECHE, Church Crookham (GB); Richard Thomas Reich, Farnham (GB); Peter Dobson, Rowledge (GB); Michael Wickham, Epsom (GB)

(21) Appl. No.: 13/082,548

(22) Filed: Apr. 8, 2011

(30) Foreign Application Priority Data
Apr. 16, 2010 (GB) 1006389.9

(51) Int. Cl. B23K 10/00

(52) U.S. Cl. 219/121.48

(57) ABSTRACT

The present invention provides a hand-held device 10 for providing a flow of plasma for treatment of a treatment region. The device comprises a plasma cell 16 defining a volume in which gas passing through a cell inlet from a gas source 22 can be energised to form a plasma and discharged through a cell outlet for treatment of a treatment region by said generated plasma, and a plurality of electrodes for receiving electrical power for energising gas in the cell to form a plasma, wherein the device comprises a valve arrangement 32 operable in an open condition to allow the discharge of plasma from the device to the treatment region and in a closed condition to resist the passage of ambient contaminants into the device in the absence of gas flow through the device from the gas source.

### BACKGROUND OF THE INVENTION

The present invention relates to a device for providing a flow of plasma. In particular the invention is directed towards a device used which generates non-thermal plasma for treating an oral region of a human or animal body.

Systems for the generation of non thermal gas plasma are known and have utility in a number of fields such as industrial, dental, medical, cosmetic and veterinary fields for the treatment of the human or animal body. Non-thermal gas plasma generation can be employed to promote coagulation of blood, cleaning, sterilisation and removal of contaminants from a surface, disinfection, reconnection of tissue and treatment of tissue disorders without causing significant thermal tissue damage.

Hereto, the application of non-thermal plasmas has been confined to controlled environments, such as in industry or clinics, in which the gas or gas mixture which is ionised can be closely controlled. This may be important in some treatments because the generation of unwanted gas species may cause injury, particularly over extended exposure.

### SUMMARY

The present invention provides a hand-held device for providing a flow of non-thermal gaseous plasma for treatment of a treatment region, the device comprising a plasma cell defining a volume in which gas passing through a cell inlet from a gas source can be energised to form a plasma and discharged through a cell outlet for treatment of a treatment region by said generated plasma, and at least one or a plurality of electrodes for receiving electrical power for energising gas in the cell to form a plasma, wherein the device comprises a valve arrangement operable in an open condition to allow the discharge of said plasma from the device to the treatment region and in a closed condition to resist the passage of ambient contaminants into the device in the absence of gas flow through the device from the gas source.

The valve arrangement thereby resists the ingress of undesirable contaminants into the plasma cell so that flushing of the plasma cell by release of gas from the gas source can be reduced or eliminated prior to device use.

The device may provide a flow path along which plasma can be conveyed from the cell outlet for discharge through a device orifice. The flow path may have a first portion proximate the cell and a second portion proximate the orifice, wherein the relative orientation of the first portion and the second portion is adjustable so that in the first condition of the valve arrangement the first and second portions are adjusted to co-operate to allow plasma to flow from the cell outlet to the orifice and in the second condition of the valve arrangement the first and second portions are adjusted to resist flow of said contaminants.

The first portion of the flow path may be mounted for angular displacement relative to the second portion of the flow path, and in the first condition of the valve arrangement the first portion is aligned with the second portion and in the second condition of the valve arrangement the first portion is misaligned with the second portion.

The plasma cell may be formed between the electrodes and the relative orientation of the electrodes is adjustable, so that when the electrodes are appropriately adjusted, either by a user or automatically, in the open condition of the valve arrangement the cell outlet is open and in a closed condition of the valve arrangement the cell outlet is closed.

The electrodes may comprise a radially outer electrode which forms the cell outlet and a radially inner electrode which is shaped to close the cell outlet, the electrodes forming therebetween a generally annular plasma cell, wherein the electrodes are configured for relative axial movement such that in one relative axial orientation of the electrodes the cell opening is closed and in another relative axial orientation discharge of plasma through the opening is allowed.

The device may comprise a switch operable by a user of the device for energising the electrodes to generate a plasma in the plasma cell, and wherein operation of the switch causes the valve arrangement to be adjusted from the closed condition to the open condition.

At least one of said adjustable components of the device may comprise an electrical contact which in the open condition of the valve arrangement closes electrical contact for energising the electrodes and in the closed condition of the valve arrangement opens said electrical contact.

In one arrangement, the valve arrangement comprises biasing means for biasing the valve to said closed condition. The bias of the valve arrangement is preferably selected to allow the valve to open when plasma is discharged from the cell.

### BRIEF DESCRIPTION OF THE DRAWINGS

In order that the invention may be more clearly understood reference will now be made to the accompanying drawings, given by way of example only, in which:

FIG. 1 is a schematic view of an embodiment of a device according to the present invention;

FIG. 2 shows a modification of the device shown in FIG. 1;

FIG. 3 shows a further modification of the device shown in FIG. 1;

FIGS. 4 and 5 show a still further modification of the device shown in FIG. 1;

FIGS. 6 and 7 show another modification of the device; and

FIGS. 8 and 9 show yet another modification of the device; and

FIGS. 10 and 11 show a further modification of the device.

### DETAILED DESCRIPTION OF PREFERRED EMBODIMENTS

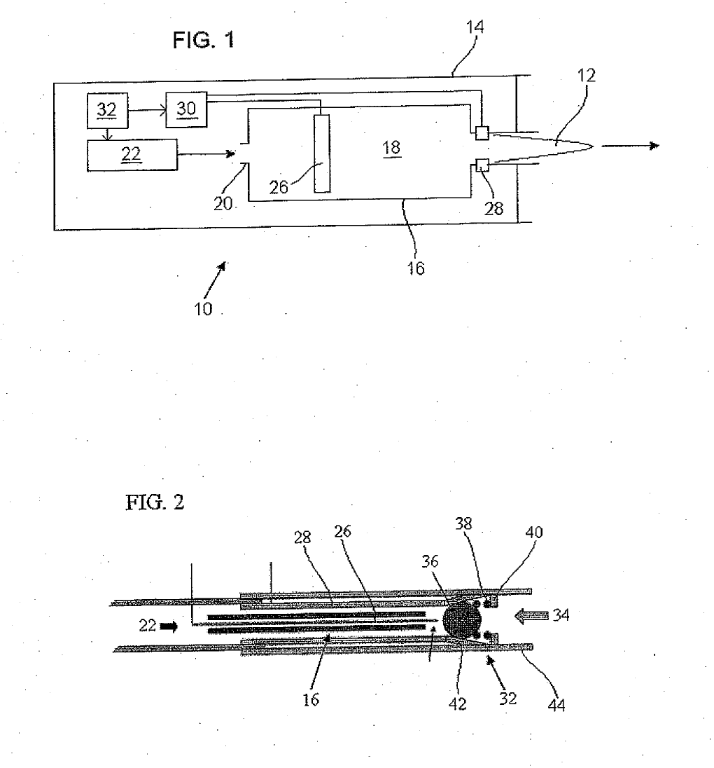

Referring to FIG. 1, a device 10 is shown for generating a non-thermal gaseous plasma which may be in the form of a gas plume 12 emitted from the device. References to plasma herein are to non-thermal gaseous plasmas. The device is configured to be hand-held and operated and therefore should be of a mass, size and shape enabling a typical user of the device to operate the device for treating a treatment region.

The device 10 comprises a housing 14 configured to be held by hand and in which the components of the device are housed. The housing also provides electrical insulation from high electrical potentials generated within the housing during use of the device.

A plasma cell 16 defines a volume 18 in which gas passing through a cell inlet 20 from a gas source 22 can be energised to form a plasma and discharged through a cell outlet 24 for treatment of a treatment region by the generated plasma. A plurality of electrodes 26, 28 are provided for receiving electrical power from a source of electrical power 30 for energising gas in the cell 16 to form a plasma.

A more detailed view of part of the device is shown in FIG. 2. The device comprises a valve arrangement 32 operable in an open condition to allow the discharge of plasma from the device to the treatment region and in a closed condition (as shown) to resist the passage of ambient contaminants 34 into the device in the absence of said discharge. The valve arrangement comprises a ball 36 biased to a closed condition by a spring 38 located between the ball and a spring seat 40. Travel of the ball is limited by ball seat 42. In use, gas discharged from plasma cell 16 causes the ball 36 to move against the bias of the spring which forms an annular opening between the ball and the ball seat 42 allowing plasma to be discharged through device orifice 44. In the absence of gas discharge, the ball 36 is biased by the spring against ball seat 40 thereby closing the device orifice.

Impurities, or contaminants, can affect plasma and resulting plume compositions. One source of such impurities is the infusion of air into the plasma cell when the device is not being used. In order to remove such contaminants, each operational period may start with a gas purge from the gas source. However, purging the device in this way reduces the amount of gas available for treatment and therefore reduces the life time of the device between refills. The invention helps to reduce purge time or possibly eliminate it altogether.

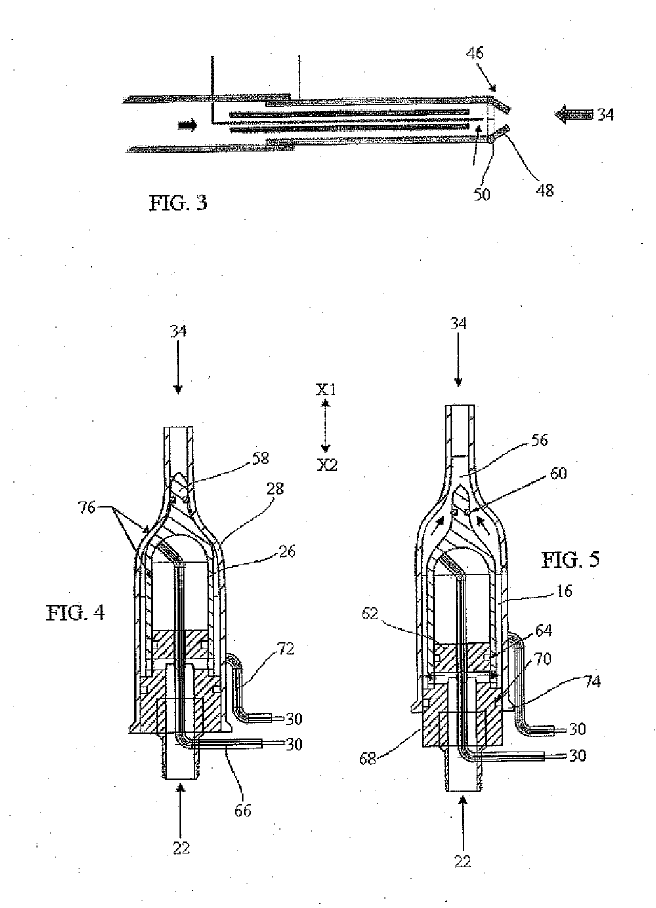

A modification of the device is shown in FIG. 3. In this arrangement, a modified valve arrangement 46 in an open condition (as shown) allows the discharge of plasma from the device to the treatment region and in a closed condition resists the passage of ambient contaminants 34 into the device in the absence of said discharge. The valve arrangement 46 comprises a flap arrangement which in this example comprises two flaps 48 pivotally mounted at the device orifice by respective pivots 50. The flaps can pivot through approximately 90° from a closed condition generally orthogonal to housing 52 in the absence of plasma discharge to a fully open condition generally parallel to housing 52. The flap valves are rotationally biased to pivot to the closed condition in the absence of plasma discharge.

A further modification of the device is shown in FIGS. 4 and 5. In this, arrangement, a modified valve arrangement 54 is shown in an open condition (FIG. 5) to allow the discharge of plasma from the device to the treatment region and in a closed condition to resist the passage of ambient contaminants 34. The device in these Figures comprises a radially outer electrode 28 which forms the cell outlet 56 and a radially inner electrode 26 having a protrusion 58 shaped to close the cell outlet. The electrodes 26, 28 form therebetween a generally annular plasma cell 16. The electrodes are configured for relative axial movement such that in one relative axial orientation of the electrodes (shown in FIG. 4) the cell opening 56 is closed and in another relative axial orientation (shown in FIG. 5) discharge of plasma through the opening is allowed. The protrusion 58 preferably comprises a seat 60 for an O-ring seal for sealing the cell opening 56 in the closed condition.

The inner electrode 26 has an open end distal from the cell outlet 56 which is closed with a closure member 62 that receives an electrical connector 66 for connecting electrode 26 to power supply 30. The closure member may also comprise an O-ring seat 64 for sealing the open end of the electrode. Outer electrode 28 also has an open end distal from the cell outlet 56 which is closed by closure member 68 that receives electrical connector 66. Member 68 has a fixed spacing from the inner electrode, but is configured with the outer electrode to allow sliding axial movement of the outer electrode. Closure member may also comprise an O-ring seat 70 for sealing the open end of the electrode. An electrical connection is made between the outer electrode and power supply 30 by electrical connector 72. As described in more detail below the electrical connection may in one arrangement be selective depending on the relative orientation of the electrodes.

In use, the cell outlet 56 is opened by movement of outer electrode in direction X1 and closed by movement of the outer electrode in direction X2. Movement by a user of outer electrode may initiate and terminate operation of device 10. This arrangement is preferable to ensure that a user opens the cell outlet when required for operation and closes the cell outlet to resist the passage of contaminants when the device is not in use. In this regard, the outer electrode 28 may comprise an electrical connection portion 74 which closes electrical contact with electrical connector 72 when the outer electrode is in the orientation shown in FIG. 5 but opens the electrical contact when the outer electrode is in the orientation shown in FIG. 4.

The electrodes may be constructed from a dielectric material such as a ceramic which has suitable dielectric properties and is inert. Surfaces 76 of respective electrodes are coated with a layer of metal forming dielectric barrier electrode arrangement for applying an electric field to the plasma cell 16. The electrodes alternately become the cathode and the anode of the arrangement when driven by an appropriate AC power supply, although for safety the outer electrode is maintained at a potential which is close to the potential of a user.

The metallised surfaces may extend to or beyond the cell outlet 56 for sustaining the plasma until it is relatively close to the treatment region. This is particularly useful if the plasma has a short life.

The arrangement shown in FIGS. 4 and 5 generates plasma efficiently. In this regard, the uniform geometry between the electrodes forms a ring of discharge, through which all the gas from gas source 22 must pass before exiting through the cell outlet 56.

The geometry of the valve arrangement also serves the purpose of having a relatively slow gas flow in the plasma chamber and a corresponding increase in gas flow speed as it leaves the chamber thereby minimising the decay time for the active species between production and eventual treatment region. The exit tube may be formed by a continuously tapering duct which accelerates the gas speed to minimise decay losses.

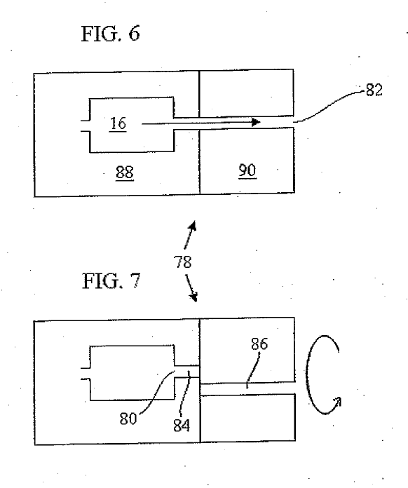

In a further modification shown in FIGS. 6 and 7, which show only relevant parts of the device for brevity, the valve arrangement 78 comprise a flow path along which plasma can be conveyed from the cell outlet 80 for discharge through a device orifice 82. The flow path has a first portion 84 proximate the cell 16 and a second portion 86 proximate the orifice 82. The relative orientation of the first portion and the second portion is adjustable so that in the first condition of the valve arrangement shown in FIG. 6 the first and second portions are adjusted to co-operate to allow plasma to flow from the cell outlet to the orifice and in the second condition of the valve arrangement shown in FIG. 7 the first and second portions are adjusted to resist flow of said contaminants. Device part 88 comprises the plasma cell and the first portion 84 of the flow path and device part 90 comprises the device orifice and the second portion of the flow path. Device parts 88 and 90 are mounted to one another to allow relative pivotal movement from the position shown in FIG. 6 to the position shown in FIG. 7, so that the first portion of the flow path is can be angular displaced relative to the second portion of the flow path, and in the first condition of the valve arrangement the first portion is aligned with the second portion and in the second condition of the valve arrangement the first portion is misaligned with the second portion.

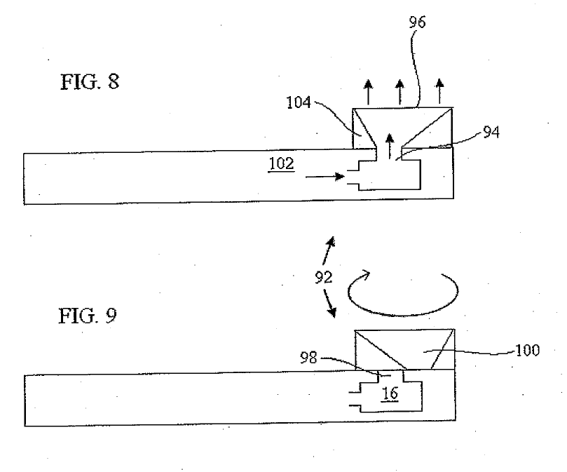

In a still further modification shown in FIGS. 8 and 9, which show only relevant parts of the device for brevity, the valve arrangement 92 comprise a flow path along which plasma can be conveyed from the cell outlet 94 for discharge through a device orifice 96. The flow path has a first portion 98 proximate the cell 16 and a second portion 100 proximate the orifice 96. The relative orientation of the first portion and the second portion is adjustable so that in the first condition of the valve arrangement shown in FIG. 8 the first and second portions are adjusted to co-operate to allow plasma to flow from the cell outlet to the orifice and in the second condition of the valve arrangement shown in FIG. 9 the first and second portions are adjusted to resist flow of said contaminants. Device part 102 comprises the plasma cell and the first portion 98 of the flow path and device part 104 comprises the device orifice 96 and the second portion 100 of the flow path. Device parts 102 and 104 are mounted to one another to allow relative pivotal movement from the position shown in FIG. 8 to the position shown in FIG. 9, so that the first portion of the flow path is can be angular displaced relative to the second portion of the flow path, and in the first condition of the valve arrangement the first portion is aligned with the second portion and in the second condition of the valve arrangement the first portion is misaligned with the second portion. This valve arrangement is particularly suited when the device 10 is adapted for use in treating the teeth of a user inside an oral cavity. In this regard, the device 10 is shaped similarly to an electric tooth brush.

The pivotal device parts 102 and 104 are mounted to allow relative pivotal movement about an axis generally perpendicular to the main axis of the device, whereas in FIGS. 6 and 7 the device parts 88 and 90 are mounted to allow relative pivotal movement about an axis generally parallel to the main axis of the device.

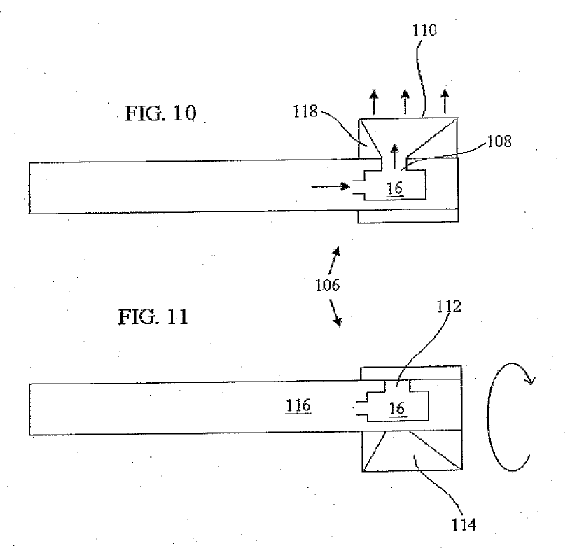

In another arrangement shown in FIGS. 10 and 11, which show only relevant parts of the device for brevity, the valve arrangement 106 comprise a flow path along which plasma can be conveyed from the cell outlet 108 for discharge through a device orifice 110. The flow path has a first portion 112 proximate the cell 16 and a second portion 114 proximate the orifice 110. The relative orientation of the first portion and the second portion is adjustable so that in the first condition of the valve arrangement shown in FIG. 10 the first and second portions are adjusted to co-operate to allow plasma to flow from the cell outlet to the orifice and in the second condition of the valve arrangement shown in FIG. 11 the first and second portions are adjusted to resist flow of said contaminants. Device part 116 comprises the plasma cell and the first portion 112 of the flow path and device part 118 comprises the device orifice 110 and the second portion 114 of the flow path. Device part 118 comprises a sleeve which is fitted for rotation about the main axis of the device 112 from the position shown in FIG. 10 to allow flow along the flow path to the position shown in FIG. 11 to prevent such flow.

What is claimed is:

1. A hand-held device for providing a flow of non-thermal gaseous plasma for treatment of a treatment region, the device comprising a plasma cell defining a volume in which gas passing through a cell inlet from a gas source can be energised to form a plasma and discharged through a cell outlet for treatment of a treatment region by said generated plasma, and a plurality of electrodes for receiving electrical power for energising gas in the cell to form a plasma, wherein the device comprises a valve arrangement operable in an open condition to allow the discharge of said plasma from the device to the treatment region and in a closed condition to resist the passage of ambient contaminants into the device in the absence of gas flow through the device from the gas source.

2. A device according to claim 1, comprising a flow path along which plasma can be conveyed from the cell outlet for discharge through a device orifice, the flow path having a first portion proximate the cell and a second portion proximate the orifice, wherein the relative orientation of the first portion and the second portion is adjustable so that in the first condition of the valve arrangement the first and second portions are adjusted to co-operate to allow plasma to flow from the cell outlet to the orifice and in the second condition of the valve arrangement the first and second portions are adjusted to resist flow of said contaminants.

3. A device according to claim 2, wherein said first portion of the flow path is mounted for angular displacement relative to the second portion of the flow path, and in the first condition of the valve arrangement the first portion is aligned with the second portion and in the second condition of the valve arrangement the first portion is misaligned with the second portion.

4. A device according to claim 1, wherein the plasma cell is formed between the electrodes and the relative orientation of the electrodes is adjustable, so that when, the electrodes are adjusted, in the open condition of the valve arrangement the cell outlet is open and in a closed condition of the valve arrangement the cell outlet is closed.

5. A device according to claim 4, wherein the electrodes comprise a radially outer electrode which forms the cell outlet and a radially inner electrode which is shaped to close the cell outlet, the electrodes forming therebetween a generally annular plasma cell, wherein the electrodes are configured for relative axial movement such that in one relative axial orientation of the electrodes the cell opening is closed and in another relative axial orientation discharge of plasma through the opening is allowed.

6. A device according to claim 2, comprising a switch operable by a user of the device for energising the electrodes to generate a plasma in the plasma cell, and wherein operation of the switch causes the valve arrangement to be adjusted from the closed condition to the open condition.

7. A device according to claim 6, wherein at least one of said adjustable components of the device comprises an electrical contact which in the open condition of the valve arrangement closes electrical contact for energising the electrodes and in the closed condition of the valve arrangement opens said electrical contact.

8. A device according claim 1, wherein the valve arrangement comprises biasing means for biasing the valve to said closed condition.

9. A device according to claim 8, wherein the bias of the valve arrangement is selected to allow the valve to open when plasma is discharged from the cell.

10. A hand-held device for providing a flow of non-thermal gaseous plasma for treatment of a treatment region, the device comprising a plasma cell defining a volume in which gas passing through a cell inlet from a gas source can be energised to form a plasma and discharged through a cell outlet for treatment of a treatment region by said generated plasma, and at least one electrode for receiving electrical power for energising gas in the cell to form a plasma, wherein the device comprises a valve arrangement operable in an open condition to allow the discharge of said plasma from the device to the treatment region and in a closed condition to resist the passage of ambient contaminants into the device in the absence of gas flow through the device from the gas source.
